(19) United States
(12) Patent Application Publication
(10) Pub. No.: US 2011/0187291 A1
(43) Pub. Date: Aug. 4, 2011

(54) Lighting Control System

(76) Inventor: West Plischke, Los Angeles, CA (US)

(21) Appl. No.: 12/697,966

(22) Filed: Feb. 1, 2010

(51) Int. Cl. H05B 37/02

(52) U.S. Cl. 315/312

(57) ABSTRACT

A method and system includes a set of lamps and programmable controller. The programmable controller can automate wavelength and intensity settings for the set of lamps in accordance with a user-defined sequence that is specifically suited to a plant type and a state of plant growth. The method and system give plants the optimum conditions for growth including the optimum wavelengths, light intensities, energy and timing for their particular stage of growth.

### FIELD OF THE INVENTION

The embodiments of the invention relate to a system for managing lighting. More specifically, the embodiments of the invention relate to a method and system for generating a program for controlling a set of lights for horticultural purposes to maximize the growing potential of plants.

### BACKGROUND

Lighting systems for growing plants in greenhouses or similar controlled environments offer basic functionality. The basic functionality provided by these lighting systems limits a growers ability to control the lighting to maximize the growth for the plants as well as maintain the health of the plants and control other characteristics of the plants. These lighting systems include manual interfaces for setting timers and similar simple mechanisms for turning on and turning off the lamps in the lighting system. The positioning and direction of lighting is separately and manually controlled.

Some lamps provide controls that offer the ability to adjust the spectrum of the light output by the lamp. Different types of plants benefit from different ranges of the light spectrum during their growth. For example, some plants can benefit during certain phases of their development from higher levels of ultraviolet or blue light spectrum. However, this adjustment is limited to manual controls, timers and on/off switches. These limited options do not enable the maximum potential of growth for plants to be realized. Each type of plant has separate and distinct growing needs that cannot be accommodated by these lighting systems. Many plants have complex needs in regard to their growth and health. Over the course of a day, week, month or year the ideal light spectrum exposure for a plant can vary significantly. The existing lighting system do not provide the control necessary to accommodate these needs.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1 is a diagram of one embodiment of a networked lighting system.

FIG. 2 is a diagram of one embodiment of a controller module for the lighting system.

FIG. 3 is a diagram of one embodiment of the components of the controller module for the lighting system.

FIG. 4 is a flowchart of one embodiment of the process for the operation of the controller module.

FIG. 5 is a diagram of one embodiment of a graphical user interface for light program design application.

FIG. 6 is a flowchart of one embodiment of a process for defining a program for lighting control.

### DETAILED DESCRIPTION

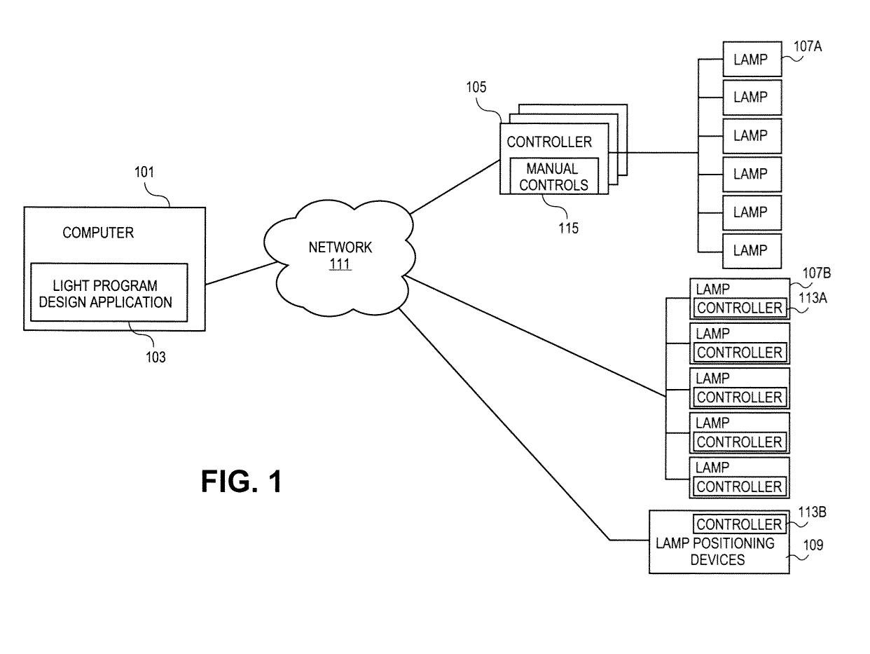

FIG. 1 is a diagram of one embodiment of a networked lighting system. The networked lighting system can include a computer 101, light program design application 103, a set of controller modules 105, and a set of lamps 107A, 10713. A ‘set,’ as used herein, refers to any positive whole number of items including one item. The networked lighting system can also include a set of lamp positioning devices 109 or similar auxiliary components that work in conjunction with the lighting controls. Each of these components can be in communication with one another through a network 111.

The network 111 can be any type of communication medium including a local area network (LAN), a wide area network (WAN), such as the Internet, or similar communication system. The network 111 can be composed of any combination of wired and wireless components and include any number of intermediary networking elements (e.g., routers, access points, hubs and similar devices) between those that are illustrated in the diagram.

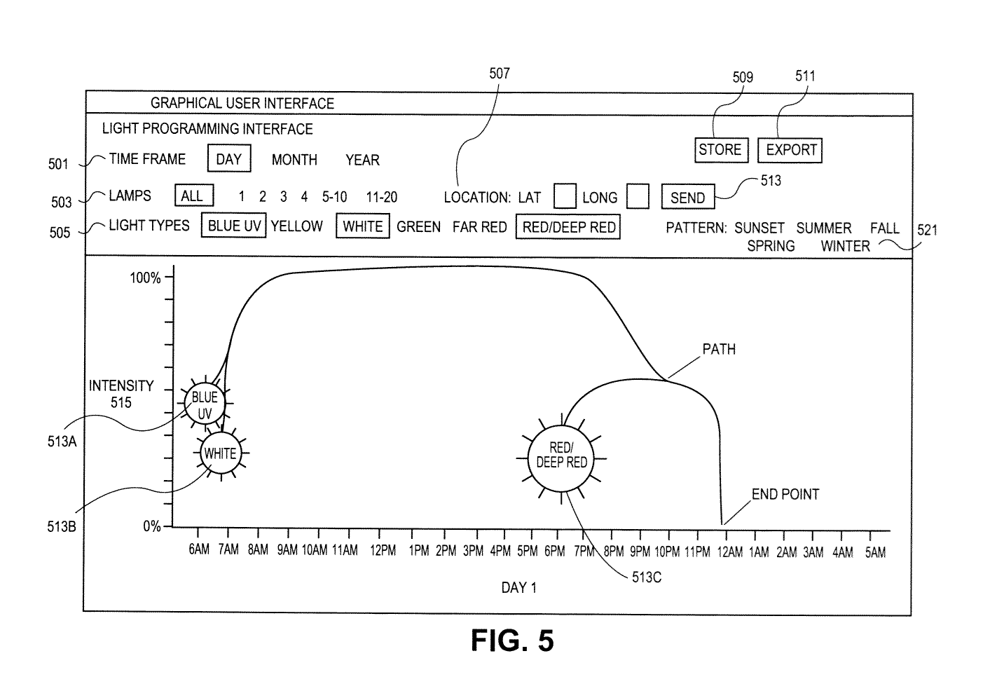

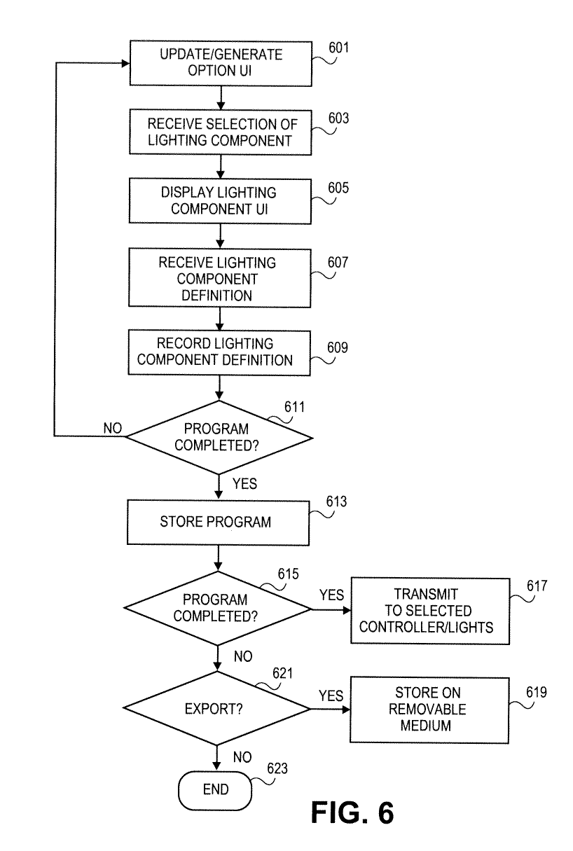

The computer 101 can be any type of computing device including a desktop computer, handheld computer, laptop computer, console device, server or similar computing device. The computer 101 stores and executes a light program design application 103. The light program design application 103 enables a user to generate a program for the networked sets of lights 107A, 10713, as well as, the other peripheral devices 109 to manage the care of plants for horticultural purposes. The function and interface of the light program design application 103 are described in further detail herein below in regard to FIGS. 5 and 6.

The lighting system can include a set of controller modules 105. The controller modules 105 execute the user defined programs from the light program design application 103 and generate a set of commands or signals to the individual lamps 107A to adjust their settings in accordance with the program. These changes in settings can include adjusting light intensity for any range of the light spectrum output by the lamps and turning on and off the lamps. The controller modules can individually control each of the lamps in the set of lamps 107A. The controller modules can control any number of lamps. In some embodiments, the controller modules can be restricted to controlling a fixed number of lights or can have an adjustable number of lamps that they can individually control. Any number of controller modules can be utilized in the networked lighting system. The controller modules can execute separate lighting programs or can work in concert to execute a single lighting program or a set of shared lighting programs.

In one embodiment, the controller modules can also include a set of manual controls 115 that allows the user to turn on and off the automated settings in the form of the light program received from the light program design application. Manual controls can be used to directly adjust the settings of the individual lamps in the set lamps 107A. These manual controls can include any type of controls including buttons, touch screen displays or similar interactive features that can be used to enable the adjustment of any of the characteristics of the lamps to be adjusted. The controller modules can also be used to adjust the characteristics of other auxiliary devices or peripheral devices such as lamp positioning devices, including vertical light movers and similar devices that affect the use of the lamps.

In one embodiment, the controller module functionality can be embedded in each of the lamps 107B and the other devices 113B, such as lamp positioning devices. These controller modules 113B can be embedded within each of the devices or can be shared between devices. The controller modules 113B can be discrete modules housed within the lamps 107B and other devices 113B. In another embodiment, the controller module functionality is integrated into the circuitry of the lamps 107B or peripheral devices 113B.

One of ordinary skill in the art would understand that the controller modules, lamps and peripheral device configurations can be any combination of an external set of controller modules 105, an internal set of controllers modules 113A, 113B and configurations that include both external 105 and internal controllers 113A, 113B with shared or divided functionality. The illustrated networked lighting system is provided by way of example and one skilled in the art would understand that the principles and structures described in regard to this example are applicable to other configurations.

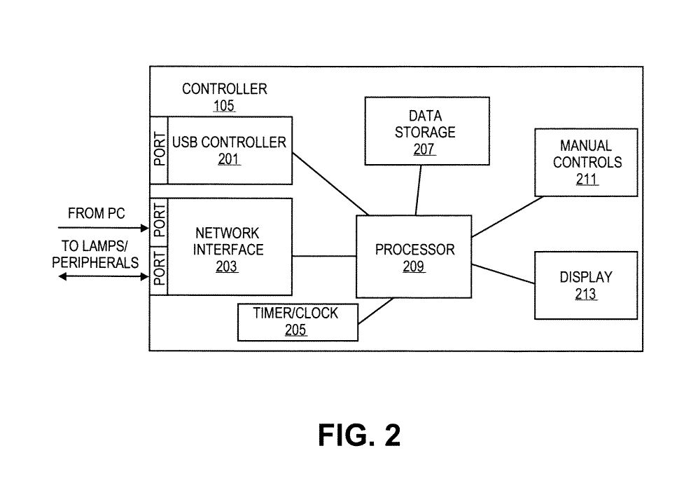

FIG. 2 is a diagram of one embodiment of the components of the controller module 105. In one embodiment, the controller module 105 includes a universal serial bus (USB) controller 201 or similar physical media port, a network interface 203, a timer or clock 205, a data storage unit 207, manual controls 211, display 213, processor 209 and similar components. In some embodiments, either the physical media port such as USB controller 201 or the network interface 203 can be omitted.

In one embodiment, the controller module 105 includes a USB controller 201 or similar physical media port controller to receive light programs from a removable media source such as a USB memory stick. The USB controller 201 can work in conjunction with the processor 209 to transfer the light program to the local data storage 207 or can be used to access the light program that is executed directly from a removable storage device connected to the USB controller 201 by the processor 209. In another embodiment, the controller module 105 can receive light programs from a remote PC through a network interface 203. The network interface 203 can also be used to communicate with any number of lamps or peripheral devices. The processor 209 generates the commands to be sent to the lights through the network interface 203 by interpretation or execution of the light programs that are stored in the data storage 207 or removable media.

The processor 209 can be any type of general purpose or application specific processing device. The processor 209 can be an application specific integrated circuit (ASIC) or general purpose processor. The processor 2009 coordinates the movement of data between the different components of the controller module 105 and interfaces with the manual controls 211 and data display 213 to receive commands directly from the user and to display feedback to the user. The processor 209 loads and executes or interprets light programs stored in the data storage 207 or received through the USB controller 201 and transmits the commands through the network interface 203. The processor 209 can utilize the functionality of a timer or clock 205 to implement time sensitive aspects of the light programs. For example, changes in lamp settings can be programmed to occur at specified times of day or on specific dates.

The network interface 203 can be any type of communication interface including Ethernet, fiber optic, wireless or similar communication interface. Wireless network interfaces can include 802.11 B/ G or N, Bluetooth, Infrared (IR) or similar wireless technologies. The controller module 105 can include a single network interface 203 or can include any number of network interfaces 203 to enable communication with additional devices or using different communication mediums.

The manual controls 211 can include any combination of buttons, sliders, touch screens or similar physical input controls that enable a user to modify the settings of a set of networked lamps. These settings may be stored in a data storage unit 207 and implemented by the processor 209 as commands that are transmitted to the lamps through the network interface 203. The processor 209 can generate any type of display as feedback to the user indicating the mode of operation, the current settings and similar information which can be displayed through a display 213. This display 213 can be a light emitting diode (LED) display, a set of individual LEDs, a liquid crystal display (LCD) or similar display device. The data storage unit 207 can be any type of persistent storage medium including static random access memory (RAM), magnetic or optical disk, Flash memory or similar storage medium.

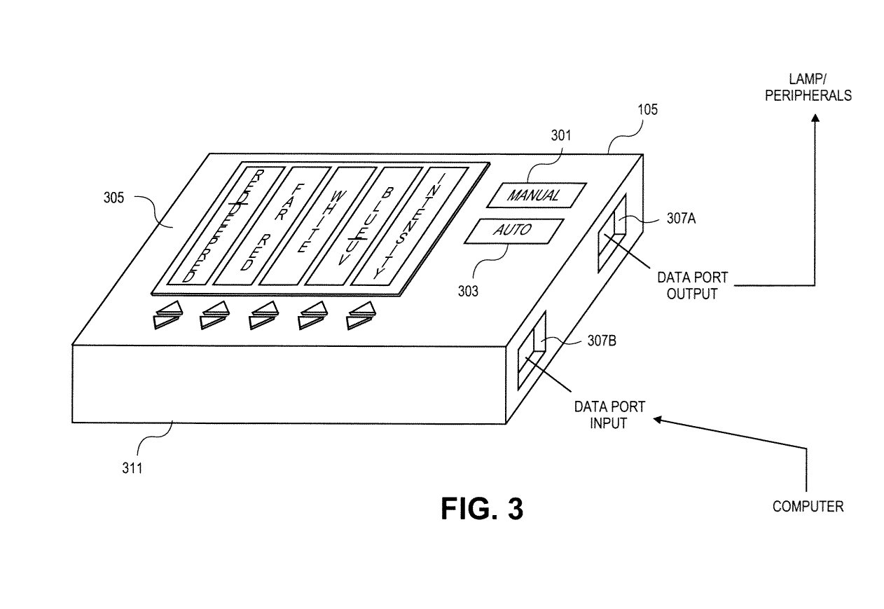

FIG. 3 is a diagram of one example of an embodiment of an external controller module. The example controller module 105 includes a set of data ports 307A, 307B, which are tied to the network interface and a set of manual input devices 301, 303 and 305. The controller module 105 can have any form factor or shape. The controller module 105 can include housing 311 to enclose all of the components and protect these components from environmental conditions. The housing 311 of the controller module can be designed to withstand the conditions of a greenhouse or similar horticultural environments to protect the circuitry from humidity and temperature variances.

The manual controls 301, 303, 305 can include a series of displays 305 that provide feedback regarding the settings of the attached lamps. The settings can include displays of the current intensity of each of the supported range of the light spectrum such as deep red, infra red, white, blue/UV, and similar characteristics of the lamps including overall intensity, on/off status, manual mode or automatic mode.

The controller module 105 can include any number of data ports. In one embodiment, a single input port 307B and a single output port 307A are provided. The output port 3071 provides direct communication with a single lamp or peripheral device or a router or hub that connects the controller module 105 to numerous lamps or peripheral devices. Similarly, the input port 30713 can directly or indirectly couple the controller module 105 with a computer to receive light programs from a light program design application. In other embodiments, the data ports 307A, 30713 are omitted and wireless technology is utilized to communicate with the lamps and peripheral devices.

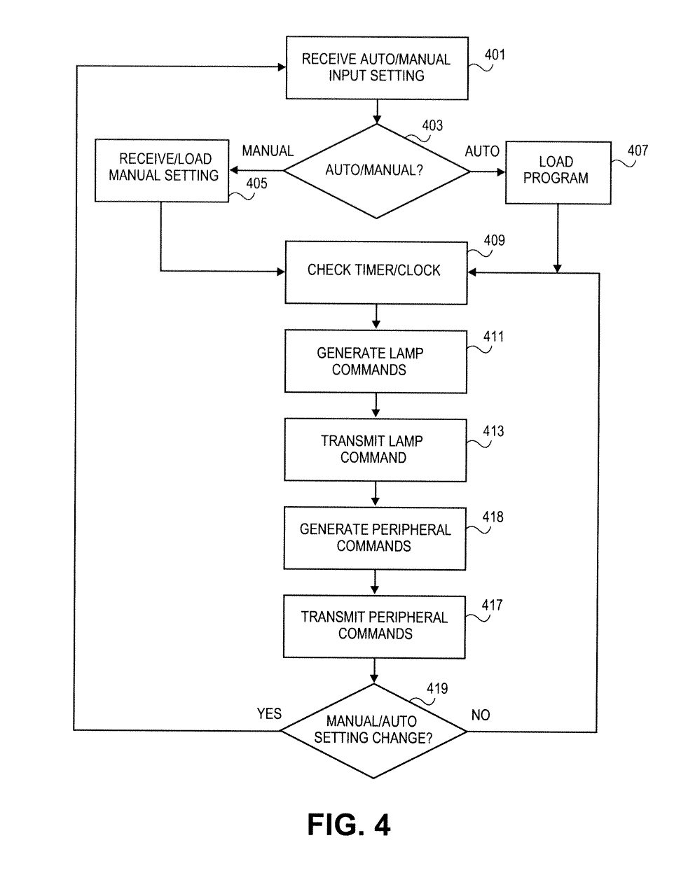

FIG. 4 is a flowchart of one embodiment of the operation of the controller module. The operation of the controller module can be implemented by the processor, data storage and similar components of the controller module. In one embodiment, the process begins by receiving an input selection to designate the mode of the controller module as being in either an automatic mode or a manual mode (Block 401). This setting may be designated by an external computer over a network interface or through the manual input interface. The processor receives this input and determines the appropriate mode (Block 403). If a manual mode has been selected, then the processor can receive or load the manual settings from the data storage unit or from the network interface, removable media or from the manual input mechanisms (Block 405). If the automatic setting has been selected, then a light program is loaded from the local data storage unit or is received over the network interface or through the physical media port (Block 407).

The processor can check the local timer or clock to determine a current time for use in executing the program that has been loaded or to the manual settings, which can also rely on time (Block 409). Based on the input settings for the loaded program, the processor generates a set of time sensitive commands to be provided to the lamps to adjust the settings to those defined by the program or the manual settings (Block 411). These commands are then transmitted to the lamps through the network interface or similar communication mechanism (Block 413). In the embodiment where the controller module is embedded within the lamps or peripheral devices, then the controller module can directly adjust these characteristics of the light being produced by the lamp.

The processor then generates any peripheral commands to control peripheral devices such as lamps positioning devices including vertical light movers and similar devices (Block 415). These commands are then communicated to the devices through the network interface or similar communication mechanism (Block 417). The processor may then check to see if the manual or automatic settings have been changed either by reception of commands through the network interface, the removable media port or through the manual input mechanism circuitry (Block 419). If no change in the settings has occurred then the process continues until all the manual settings have been updated or the light program has been executed over time. If the settings have changed, then the new settings are then detected (Block 401, 403). The operation of the controller module then continues according to the newmanual settings or received program.

FIG. 5 is a diagram of one example of an embodiment of a graphical user interface for a light program design application. In one embodiment, the graphical user interface of the light programming design application provides a set of options for setting the time frame 501, lamp sets 503, lighting types 505, location simulation 507, patterns 521 and similar lighting characteristics or settings. These options are presented as user interface mechanisms that can be buttons, menus or similar user interface mechanisms among a selection of any combination of characteristics and settings. This graphical user interface enables the user to flexibly design any program for the available lighting system, such that each individual lamp can be separately programmed or any grouping of lamps can be programmed for any timeframe and for any range of the light spectrum. In other embodiments, a defined lighting program controls all lamps attached to a controller module or similar restrictions can be imposed on the application of the define lighting program.

Programming options also include location simulation, where the lighting conditions of a specified location can be simulated. Programming option can include any number of pre-defined patterns 521 that can be selected through the graphical user interface. The graphical user interface can provide a menu or set of user interface mechanisms for storing 509, exporting 511 or sending 523 any lighting programs defined through the graphical user interface. The lighting programs can be exported to a physical storage medium or sent to the controller module over a network. Any selected set of lamps, time frame and light spectrum range can be further defined using a drag and drop or similar interface mechanism. For example, a light intensity over time for each of the light spectrum ranges supported by a lamp or set of lamps can be defined by a user selecting an icon 513A, 513B, 513C representing a light spectrum range or similar characteristic and dragging and dropping it over a chart of the intensity over time. The defined path can then be store as an algorithm to be implemented by the controller module. For example, the user can select a red light spectrum and set an on point for 6:00 p.m. at a low intensity. A path can be drawn that increases the light intensity until 10:00 p.m. and then decreases the light intensity until the red light spectrum is inactivated at 12:00 a.m. Multiple segments of the light spectrum can be assigned or grouped to single icon, such as red and deep red. Each segment of the light spectrum can also have a separate icon and any combination of individual and grouped ranges are possible. The user can set blue/UV and white light spectrums to be activated at 6:00 a.m. and 7:00 a.m., respectively, and to increase through the day. Both light spectrum ranges decrease in intensity starting at 7:00 p.m. and then end at 12:00 a.m. as illustrated in FIG. 5. One of ordinary skill in the art would understand that these are example programs and user interface layouts. One of ordinary skill in the art would understand that similar user interface mechanisms and layouts can be used to affect the same principles and functionality. The drawings are provided by way of illustration not limitation.

FIG. 6 is a flowchart of one embodiment of the process of generating a light program design. In one embodiment, the process begins by the user opening the light design application and the application generating a set of options and user interface mechanisms (Block 601). These options and user interface mechanism can be used by the user to select a lighting component, which represents a lighting characteristic including time frame, lamp sets, light types, patterns, locations for simulation and similar characteristics.

The light program design application receives a selection of one of these lighting components (Block 603). The application can then display a lighting component user interface specific to the set of selected characteristics, such as a drag and drop interface or set of menus or similar user interface mechanism allowing the user to define a program for an interrelationship between the selected characteristics (Block 605). This set of interrelationships is received as a lighting component definition (Block 607). The lighting component definition can be recorded in any type of scripting language or representation including any type of high level executed language or interpreted language. In one embodiment, the definition can be stored as an extensible markup language (XML) document or similar type of document. The lighting component definition is then recorded (Block 609) as a part of a file that can include any number of other lighting component definitions that can be structured as a set of executable commands that can be tied to any time sequence and executed by a controller to set the attributes of a lamp or set of lamps over time using any type of signaling or any combination of machine instructions.

A check is made to determine whether the user defined program has been completed (Block 611). If the user has additional definitions to make, then the user interface continues to be updated until all the lighting component definitions have been completed and stored within the program. The completed program is then stored (Block 613). The stored program can be stored locally on the computer and can be either transmitted to a controller module or exported. If a selection has been made to transmit (Block 615) then the application utilizes available networking and network interface functionality to transmit the program to a selected controller module or lamps (Block 617). If the program is to be exported then the data program is stored in a removable medium (Block 619). The removable medium then can be taken and joined to the controller module or any number of controller modules, which can then implement the lighting program. Once this process has been completed, the application can be closed (Block 623).

In one embodiment, the programmable light system can be implemented as a set of hardware devices. In another embodiment, any set of the system components can implemented in software (for example microcode, assembly language or higher level languages). These software implementations can be stored on a computer-readable medium. A “computer-readable” medium can include any medium that can store information. Examples of computer-readable medium include a read only memory (ROM), a floppy diskette, a CD Rom, a DVD, a flash memory, a hard drive, an optical disc or similar medium.

Thus, a method and apparatus for a networked lighting system has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
generating a user interface for designing a lighting program;
receiving a selection of a set of lamps to program through the user interface;
receiving a selection of a light spectrum from a plurality of light spectrum options;
receiving a selection of intensity over time for the light spectrum; and
recording the intensity over time for the light spectrum as the lighting program to control the set of lamps.

2. The computer-implemented method of claim 1, further comprising:
generating user interface mechanisms for selecting any one of the set of lamps, a time frame for the program, the light spectrum, a location or a pre-defined lighting program.

3. The computer-implemented method of claim 2, wherein the pre-defined lighting program simulates any one of sunrise, sunset, winter, fall, summer or spring.

4. The computer-implemented method of claim 2, wherein defining a location modifies the lighting program to simulate lighting to match the location, and wherein the location is a region or set of coordinates.

5. The computer-implemented method of claim 2, wherein the time frame options include a day, a month, a season or a year.

6. The computer-implemented method of claim 1, further comprising:
transmitting commands to each lamp in the set of lamps over a network.

7. The computer-implemented method of claim 1, further comprising:
generating commands for peripheral equipment including lamp positioning devices; and
recording the commands for the peripheral equipment in the lighting program.

8. The computer-implemented method of claim 7, further comprising:
transmitting the commands for the peripheral equipment to the peripheral equipment over a network.

9. A system comprising:
a lamp having independent controls for intensity of a plurality of light spectrum ranges; and
a controller module coupled to lamp to control the lamp by executing a user defined lighting program that sets an intensity for a light spectrum range in the plurality of light spectrum ranges.

10. The system of claim 9, wherein the controller module is coupled to the lamp over a network and transmits commands to the light over the network.

11. The system of claim 9, further comprising:
a computer to execute a graphical user interface for designing the user defined program and transmitting the lighting program over the network or storing the lighting program on a removable media compatible with the controller module.

12. A computer-readable storage medium having a set of instructions stored therein, which when executed cause a computer to perform a set of operations comprising:
generating a user interface for designing a lighting program;
receiving a selection of a set of lamps to program through the user interface;
receiving a selection of a light spectrum from a plurality of light spectrum options;
receiving a selection of intensity over time for the light spectrum; and
recording the intensity over time for the light spectrum as the lighting program to control the set of lamps.

13. The computer-readable medium of claim 12, having further instructions stored therein, which when executed cause the computer to perform the set of operations further comprising:
generating user interface mechanisms for selecting any one of the set of lamps, a time frame for the program, the light spectrum, a location or a pre-defined lighting program.

14. The computer-readable medium of claim 13, wherein the pre-defined lighting program simulates any one of sunrise, sunset, winter, fall, summer or spring.

15. The computer-readable medium of claim 13, wherein defining a location modifies the lighting program to simulate lighting to match the location, and wherein the location is a region or set of coordinates.

16. The computer-readable medium of claim 13, wherein the time frame options include a day, a month, a season or a year.

17. The computer-readable medium of claim 12, having further instructions stored therein, which when executed cause the computer to perform the set of operations further comprising:
transmitting commands to each lamp in the set of lamps over a network.

18. The computer-readable medium of claim 12, having further instructions stored therein, which when executed cause the computer to perform the set of operations further comprising:
generating commands for peripheral equipment including light positioning devices; and
recording the commands for the peripheral equipment in the program.

19. The computer-readable medium of claim 18, having further instructions stored therein, which when executed cause the computer to perform the set of operations further comprising:
transmitting the commands for the peripheral equipment to the peripheral equipment over a network.
